(19) United States
(12) Patent Application Publication
(10) Pub. No.: US 2026/0112895 A1
(43) Pub. Date: Apr. 23, 2026

(54) POWER GENERATION SYSTEM

(71) Applicant: TOYOTA JIDOSHA KABUSHIKI KAISHA, Toyota-shi (JP)

(72) Inventors: Yukinori MURAKAMI, Toyota-shi (JP); Yuma MIYAMOTO, Miyoshi-shi (JP); Daisuke IBATA, Toyota-shi (JP); Takashi FUKAI, Obu-shi (JP); Takao SAITOH, Kobe-shi (JP)

(21) Appl. No.: 19/232,944

(22) Filed: Jun. 10, 2025

(30) Foreign Application Priority Data
Oct. 18, 2024 (JP) 2024-184310

(51) Int. Cl. H02J 3/38; H02S 10/00

(52) U.S. Cl. CPC H02J 3/38; H02J 2101/24; H02S 10/00

(57) ABSTRACT

The power generation system includes a plurality of solar panels and a plurality of power conversion devices that supplies power from the solar panel to a battery. The power generation system further includes a control device configured to control power supply by the plurality of power conversion devices. The control device executes adjustment processing that is processing of increasing a decrease rate of output power of a power conversion device with a large heat load than a decrease rate of output power of a power conversion device with a small heat load when power supplied to the battery is decreased.

### CROSS-REFERENCE TO RELATED APPLICATION

This application claims priority to Japanese Patent Application No. 2024-184310 filed on Oct. 18, 2024. The disclosure of the above-identified application, including the specification, drawings, and claims, is incorporated by reference herein in its entirety.

### BACKGROUND

### 1. Technical Field

The present disclosure relates to a power generation system.

### 2. Description of Related Art

Japanese Unexamined Patent Application Publication No. 2023-41369 (JP 2023-41369 A) discloses a power generation system that supplies power generated by a solar panel to a battery.

### SUMMARY

In a power generation system, a plurality of solar panels may be used in combination. Such a power generation system includes a plurality of power conversion devices that supplies power from each of the solar panels to the battery.

A heat load generated in the power conversion device when a voltage is converted is different for each of the power conversion devices. When the heat load of the power conversion device becomes excessive, an operation of the power conversion device may be restricted or durability performance of the power conversion device may be degraded.

A power generation system for solving the above-described problem includes a plurality of solar panels and a plurality of power conversion devices., the power conversion devices supplying power from the solar panels to a battery. The power generation system further includes a control device that controls power supply via the power conversion devices. The control device executes adjustment processing that is processing of making a decrease rate of output power of a power conversion device with a large heat load larger than a decrease rate of output power of a power conversion device with a small heat load when the power supplied to the battery is decreased.

The power generation system can suppress an increase in a heat load of the power conversion device with the large heat load.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a power generation system according to an embodiment; and

FIG. 2 is a flowchart showing processing by the control device of FIG. 1.

### DETAILED DESCRIPTION OF EMBODIMENTS

### Embodiment

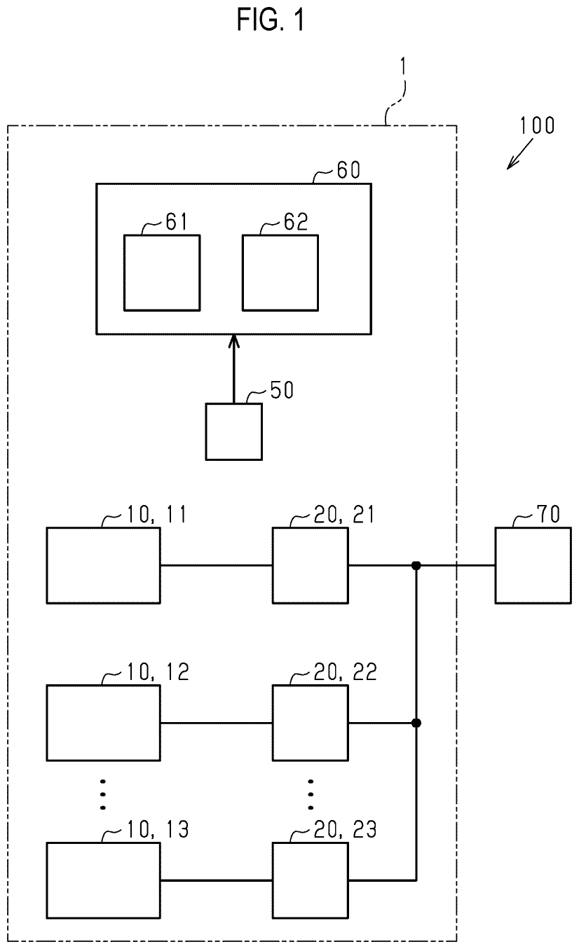

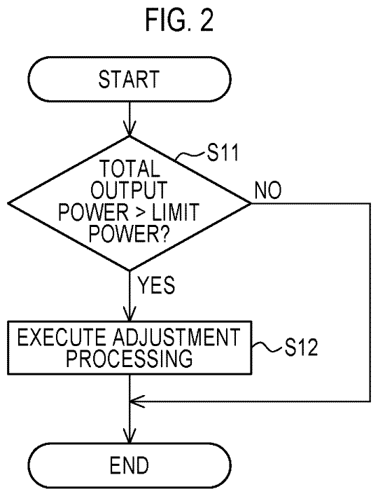

The embodiment of the power generation system will be described below with reference to FIGS. 1 and 2.

### Entire Configuration

The power generation system 1 shown in FIG. 1 is mounted on, for example, a vehicle 100. The power generation system 1 includes a plurality of solar panels 10 and a plurality of power conversion devices 20. The power generation system 1 further includes a control device 60.

The solar panel 10 is configured to be a panel shape by arranging a plurality of solar cells that generates power by being irradiated with sunlight. Examples of the installation locations of the plurality of solar panels 10 in the vehicle 100 include a front side of a roof, a rear side of the roof, an engine roof, and a back door.

The power conversion device 20 supplies the power generated by the solar panel 10 to the battery 70. The battery 70 is a secondary battery. The battery 70 stores the power supplied from the power conversion device 20. The battery 70 includes, for example, at least one of an auxiliary battery and a drive battery. The auxiliary battery supplies power to, for example, an auxiliary system mounted on the vehicle 100. The auxiliary system of the vehicle 100 is configured to include one or more auxiliaries. The auxiliary is, for example, an electric oil pump, a navigation system, or a light. The drive battery supplies power to a drive system mounted on the vehicle 100. The drive system of the vehicle 100 includes one or more motors for driving the vehicle 100. A relay circuit (not shown) is provided between the power conversion device 20 and the battery 70.

The power conversion device 20 steps down or steps up the direct-current voltage to output the direct-current voltage. The power conversion device 20 is, for example, a DC-DC converter. The power conversion device 20 is connected to the solar panel 10. The power conversion device 20 converts the output voltage of the solar panel 10 that is the input voltage into a voltage based on an instruction of the control device 60, and then outputs the voltage. The type of the power conversion device 20 may be set according to the type of the battery 70.

Each of the plurality of power conversion devices 20 has a different configuration, such as an electric circuit of the power conversion device 20 and a converted power amount. The configuration of each of the plurality of power conversion devices 20 is determined, for example, by the installation location of the power conversion device 20 in the vehicle 100. As an example, when the installation location of the power conversion device 20 is narrow, the circuit board of the power conversion device 20 is small as compared with the circuit board of the power conversion device 20 with a wide installation location.

The generated power of one solar panel 10 is supplied to the battery 70 through one power conversion device 20. As an example, the plurality of solar panels 10 includes a first panel 11, a second panel 12, and a third panel 13. The plurality of power conversion devices 20 includes a first device 21, a second device 22, and a third device 23. The first device 21 supplies the power generated by the first panel 11 to the battery 70. The second device 22 supplies the power generated by the second panel 12 to the battery 70. The third device 23 supplies the power generated by the third panel 13 to the battery 70. As a result, the total output power of the plurality of power conversion devices 20 is supplied to the battery 70.

The power generation system 1 further includes a measurement circuit 50. The measurement circuit 50 detects information on the state of each of the plurality of power conversion devices 20 and outputs the information to the control device 60. Examples of the information detected by the measurement circuit 50 will be described below.

The information detected by the measurement circuit 50 is, for example, the current and the voltage of the power conversion device 20. The current of the power conversion device 20 includes an input current to the power conversion device 20 and an output current of the power conversion device 20. The voltage of the power conversion device 20 includes an input voltage to the power conversion device 20 and an output voltage of the power conversion device 20.

The information detected by the measurement circuit 50 is, for example, the circuit temperature of the electric circuit included in the power conversion device 20. The measurement circuit 50 is, for example, a temperature sensor that measures a circuit temperature of the power conversion device 20. The measurement circuit 50 may measure the temperature of the vicinity of the power conversion device 20, for example. When the temperature of the vicinity of the power conversion device 20 is high, the heat dissipation of the power conversion device 20 is large.

The information detected by the measurement circuit 50 is, for example, an operation state of the power conversion device 20. The measurement circuit 50 outputs that the power conversion device 20 is operating to the control device 60 when the power conversion device 20 is operating. The measurement circuit 50 determines the operation state of the power conversion device 20 based on the output power of the power conversion device 20, for example.

The control device 60 includes a CPU 61 and a memory 62. The memory 62 stores, in advance, various programs in which processing to be executed by the CPU 61 is described. The CPU 61 executes a program stored in the memory 62 to control the plurality of power conversion devices 20.

The control device 60 controls the power supply by the plurality of power conversion devices 20. The control device 60 starts the power supply by the plurality of power conversion devices 20 when there is a start request, for example. In addition, the control device 60 ends the power supply by the plurality of power conversion devices 20 when there is an end request, for example. The start request and the end request are signals output from the ECU of the vehicle 100, for example. The control device 60 may be included in the ECU of the vehicle 100.

The control device 60 controls the output power of each of the plurality of power conversion devices 20 by outputting, for example, an instruction signal regarding the output voltage of the power conversion device 20 to each of the plurality of power conversion devices 20. The control device 60 controls the output voltage of each of the plurality of power conversion devices 20 with reference to the output power of each of the plurality of power conversion devices 20, for example. The control device 60 acquires, for example, the output voltage and the output current of the power conversion device 20, and calculates the output power of the power conversion device 20 by multiplying these values. The control device 60 calculates an output voltage at which the output power of the power conversion device 20 is maximized by using, for example, a known hill climbing method.

The control device 60 restricts the operation of the power conversion device 20, for example, when the circuit temperature of the power conversion device 20 is equal to or higher than a predetermined temperature. Specifically, the control device 60 decreases the output power of the power conversion device 20 or stops the supply of the power when the circuit temperature of the power conversion device 20 is equal to or higher than a predetermined temperature. By restricting the operation of the power conversion device 20 when the circuit temperature of the power conversion device 20 is equal to or higher than a predetermined temperature, it is possible to suppress the excessive increase in the heat load of the power conversion device 20.

The control device 60 decreases the total output power of the plurality of power conversion devices 20 when there is a restriction request, to decrease the supply power to the battery 70. The total output power of the plurality of power conversion devices 20 is the sum of the output power of each of the plurality of power conversion devices 20. The restriction request is a signal requesting, for example, restriction of the power supply to the battery 70. The restriction request is output, for example, from the ECU of the vehicle 100. The restriction request is output in a state in which the acceptance of the power by the battery 70 is restricted, such as a state in which the battery 70 is fully charged or a state in which the battery 70 is at a high temperature. The control device 60 controls the power conversion devices 20 such that the total output power of the plurality of power conversion devices 20 is equal to or less than the limit power when the power supplied to the battery 70 is decreased. The limit power is determined, for example, based on the power amount that the battery 70 can accept.

### Adjustment Processing by Control Device

The control device 60 controls the decrease rate of the output power of each of the plurality of power conversion devices 20 based on the heat load of each of the plurality of power conversion devices 20 when the power supplied to the battery 70 is decreased. The decrease rate of the output power is (W1-W2)/W1, where W1 is the output power before the decrease in the supply power to the battery 70, and W2 is the output power after the decrease in the supply power to the battery 70, in each of the plurality of power conversion devices 20. In a case where the output power of the power conversion device 20 is not decreased, W2 is equal to W1.

The control device 60 executes adjustment processing of increasing a decrease rate of the output power of the power conversion device 20 with a large heat load with respect to a decrease rate of the output power of the power conversion device 20 with a small heat load, when the power supplied to the battery 70 is decreased. Specifically, the adjustment processing is processing of setting a decrease rate of the output power of the power conversion device 20 with a large heat load to x (0<x≤1) and a decrease rate of the output power of the power conversion device 20 with a small heat load to y (0≤y<x) when the power supplied to the battery 70 is decreased. The adjustment processing is, for example, processing of performing power supply by the power conversion device 20 with a small heat load and stopping power supply by the power conversion device 20 with a large heat load when the power supplied to the battery 70 is decreased. The control device 60 sets, for example, the decrease rate of the output power of the power conversion device 20 with a small heat load to 0 and the decrease rate of the output power of the power conversion device 20 with a large heat load to 1. When the total output power of the plurality of power conversion devices 20 does not decrease to the limit power even when the supply of the power of the power conversion device 20 with the largest heat load is stopped, the control device 60 stops the supply of the power of the power conversion device 20 with the next largest heat load. The control device 60 repeats the above-described processing until the total output power of the plurality of power conversion devices 20 is equal to or less than the limit power.

Examples of methods in which the control device 60 determines the magnitude of the heat load of the power conversion device 20 include a first method to a third method described below. The control device 60 determines the magnitude of the heat load of each of the plurality of power conversion devices 20 by any one of the first method to the third method.

### First Method

In the first method, the control device 60 determines the magnitude of the heat load of each of the plurality of power conversion devices 20 based on the power efficiency, the magnitude being a magnitude of the output power with respect to the magnitude of the input power of each of the plurality of power conversion devices 20. The power efficiency is W4/W3, where the input power of the predetermined power conversion device 20 is W3 and the output power of the predetermined power conversion device 20 is W4. The lower the power efficiency, the greater the loss of power in the power conversion device 20. The control device 60 may store the power efficiency of each of the plurality of power conversion devices 20, and may calculate the power efficiency based on the input power and the output power output from the measurement circuit 50.

The adjustment processing of the first method is processing of increasing a decrease rate of the output power of the power conversion device 20 with low power efficiency than a decrease rate of the output power of the power conversion device 20 with high power efficiency when the power supplied to the battery 70 is decreased.

### Second Method

In the second method, the control device 60 determines the magnitude of the heat load of each of the plurality of power conversion devices 20 based on the circuit temperature related to the temperature of the electric circuit included in each of the plurality of power conversion devices 20. The control device 60 acquires the temperature of the electric circuit output from the measurement circuit 50. The control device 60 calculates a larger heat load as the circuit temperature is higher.

The adjustment processing of the second method is processing of increasing a decrease rate of the output power of the power conversion device 20 with a high circuit temperature, with respect to a decrease rate of the output power of the power conversion device 20 with a low circuit temperature, when the power supplied to the battery 70 is decreased.

### Third Method

In the third method, the control device 60 determines the magnitude of the heat load of each of the plurality of power conversion devices 20 based on the operation frequency with which each of the plurality of power conversion devices 20 has operated. The control device 60 sequentially stores the operation state of the power conversion device 20 output from the measurement circuit 50 as the operation history of the power conversion device 20. The operation history of the power conversion device 20 includes the number of times the power conversion device 20 has performed the power supply during a predetermined period until the control device 60 determines the magnitude of the heat load of the power conversion device 20 by the third method. The start of the predetermined period is, for example, the most recent time among times when the main switch of the vehicle 100 is turned on. In addition, the start of the predetermined period may be the time of factory shipment of the power conversion device 20. The control device 60 acquires the operation frequency of the power conversion device 20 based on the operation history of the power conversion device 20. The control device 60 calculates a larger heat load as the operation frequency of the power conversion device 20 is higher.

The adjustment processing of the third method is processing of increasing a decrease rate of the output power of the power conversion device 20 with a high operation frequency with respect to a decrease rate of the output power of the power conversion device 20 with a low operation frequency when the power supplied to the battery 70 is decreased.

### Processing by Control Device

Processing by Control Device 60 will be described with reference to FIG. 2. The control device 60 executes the processing of FIG. 2 when there is a restriction request in a case where the power conversion device 20 supplies the power to the battery 70.

In S11, the control device 60 determines whether the total output power of the plurality of power conversion devices 20 is larger than the limit power. When the total output power is larger than the limit power, the control device 60 proceeds to S12. When the total output power is not larger than the limit power, that is, when the total output power is equal to or less than the limit power, the control device 60 ends the processing of FIG. 2.

In S12, the control device 60 executes the adjustment processing, and ends the series of pieces of processing of FIG. 2. By executing the adjustment processing, the power supplied to the battery 70 decreases. The control device 60 continues the adjustment processing until the restriction request disappears when the adjustment processing is being executed.

### Action and Effect of Present Embodiment

(1) The power conversion device 20 generates a heat load on the power conversion device 20 by converting a voltage. The heat load causes the solder to deteriorate due to temperature change, the crack to occur due to the expansion and contraction of the metal part, and the like. The heat load is different for each of the power conversion devices 20 due to factors such as the characteristics of the power conversion device 20 and the generated power of the solar panel 10. When the heat load of the power conversion device 20 is excessively large, the operation of the power conversion device 20 may be restricted or the durability performance of the power conversion device 20 may be degraded.

In this regard, the control device 60 executes adjustment processing of increasing a decrease rate of the output power of the power conversion device 20 with a large heat load with respect to a decrease rate of the output power of the power conversion device 20 with a small heat load when the power supplied to the battery 70 is decreased. With this configuration, the decrease rate of the output power of the power conversion device 20 with a large heat load is larger than the decrease rate of the output power of the power conversion device 20 with a small heat load, and thus the temperature of the power conversion device 20 with a large heat load is less likely to increase. Therefore, it is possible to suppress an increase in the heat load of the power conversion device 20 with a large heat load.

(2) The control device 60 restricts the operation of the power conversion device 20 when the circuit temperature of the power conversion device 20 is equal to or higher than a predetermined temperature, for example. In the power generation system 1, the circuit temperature of the power conversion device 20 is suppressed from being increased by the adjustment processing, and thus the operation of the power conversion device 20 is unlikely to be restricted due to the circuit temperature of the power conversion device 20 being equal to or higher than the predetermined temperature.

(3) When the power efficiency of the power conversion device 20 is low, the loss of power in the power conversion device 20 increases. The power of the loss part is converted into heat. Therefore, the lower the power efficiency is, the larger the heat load of the power conversion device 20 is. In this regard, the control device 60 increases the decrease rate of the output power of the power conversion device 20 with low power efficiency than the decrease rate of the output power of the power conversion device 20 with high power efficiency when the power supplied to the battery 70 is decreased. With the above configuration, since the decrease rate of the output power of the power conversion device 20 with low power efficiency is larger than the decrease rate of the output power of the power conversion device 20 with high power efficiency, the loss of power in the power conversion device 20 with low power efficiency is likely to be small. As a result, it is possible to suppress an increase in the heat load of the power conversion device 20 with low power efficiency.

(4) When the circuit temperature of the power conversion device 20 is high, the heat load on the power conversion device 20 increases. In this regard, the control device 60 increases the decrease rate of the output power of the power conversion device 20 with the high circuit temperature than the decrease rate of the output power of the power conversion device 20 with the low circuit temperature when the power supplied to the battery 70 is decreased. As a result, the output power of the power conversion device 20 with a high circuit temperature is likely to be suppressed. As a result, it is possible to suppress an increase in the heat load of the power conversion device 20 with a high circuit temperature.

In addition, when the circuit temperature of the power conversion device 20 is high, the amount of heat emitted from the power conversion device 20 is large, and thus there is a possibility that a heat load is applied to the components around the power conversion device 20. With the above configuration, the output power of the power conversion device 20 with a high circuit temperature is likely to be suppressed, so that the heat load of an entirety of the power generation system 1 can be reduced.

(5) In a case where the operation frequency of the power conversion device 20 is increased, the metal part is repeatedly expanded and contracted due to the temperature change, and thus a crack is likely to occur in the metal part. In this regard, the control device 60 increases the decrease rate of the output power of the power conversion device 20 with a high operation frequency with respect to the decrease rate of the output power of the power conversion device 20 with a low operation frequency when the power supplied to the battery 70 is decreased. As a result, the output power of the power conversion device 20 with a high operation frequency is likely to be suppressed. Therefore, it is possible to suppress an increase in the operation frequency of the power conversion device 20 with a high operation frequency.

(6) The control device 60 performs power supply by the power conversion device 20 with a small heat load and stops power supply by the power conversion device 20 with a large heat load when the power supplied to the battery 70 is decreased. As a result of the output of the power from the power conversion device 20 with a large heat load being stopped, the heat load of the power conversion device 20 with a large heat load can be reduced.

### Modification Example

The present embodiment can be modified and carried out as follows. The present embodiment and the following modification examples can be carried out in combination within a technically consistent range.

The adjustment processing may be processing of stopping the output of the power from the power conversion device 20 by comparing one of the circuit temperature, the power efficiency, and the operation frequency of the power conversion device 20 with a predetermined threshold value when the power supplied to the battery 70 is decreased. The threshold value is set to a value at which the determination can be made that the heat load of the power conversion device 20 is large. When the heat load is based on the circuit temperature of the power conversion device 20, the threshold value is set to a value at which the determination can be made that the circuit temperature of the power conversion device 20 is equal to or higher than a predetermined temperature. The control device 60 stops the output of the power from the power conversion device 20 with the circuit temperature exceeding a threshold value when the power supplied to the battery 70 is decreased. When the heat load is based on the power efficiency of the power conversion device 20, the threshold value is set to a value at which the power efficiency of the power conversion device 20 can be determined to be low. The control device 60 stops the output of the power from the power conversion device 20 with the power efficiency being smaller than a threshold value when the power supplied to the battery 70 is decreased. When the heat load is based on the operation frequency of the power conversion device 20, the threshold value is set to a value at which the operation frequency of the power conversion device 20 can be determined to be high. The control device 60 stops the output of the power from the power conversion device 20 with the operation frequency exceeding a threshold value when the power supplied to the battery 70 is decreased.

The control device 60 may determine the magnitude of the heat load of each of the plurality of power conversion devices 20 by combining at least two of the first method to the third method. For example, the first method to the third method are set with a priority. The control device 60 first determines the magnitude of the heat load of each of the plurality of power conversion devices 20 in a method with the highest priority. When there is no difference in the magnitude of the heat load of each of the plurality of power conversion devices 20 by the method with the highest priority, the control device 60 determines the magnitude of the heat load of each of the plurality of power conversion devices 20 by the next method with the second highest priority.

The operation history of the power conversion device 20 may include an operation period during which the power conversion device 20 supplies power within a predetermined period. The longer the operation period of the power conversion device 20, the more likely the heat load is to occur due to the aging deterioration of the power conversion device 20. The control device 60 acquires an operation period of the power conversion device 20 based on the operation history of the power conversion device 20. The control device 60 calculates a larger heat load as the operation period of the power conversion device 20 is longer. The adjustment processing of the present modification example is processing of increasing a decrease rate of the output power of the power conversion device 20 with a large operation period with respect to a decrease rate of the output power of the power conversion device 20 with a small operation period in the case where the power supplied to the battery 70 is decreased.

What is claimed is:

1. A power generation system comprising:
a plurality of solar panels and a plurality of power conversion devices, the power conversion devices supplying power from the solar panels to a battery; and further
a control device that controls power supply via the power conversion devices, wherein the control device executes adjustment processing that is processing of making a decrease rate of output power of a power conversion device with a large heat load larger than a decrease rate of output power of a power conversion device with a small heat load when the power supplied to the battery is decreased.

2. The power generation system according to claim 1, wherein the adjustment processing is processing of making a decrease rate of a power conversion device with low power efficiency larger than a decrease rate of a power conversion device with high power efficiency when the power supplied to the battery is decreased.

3. The power generation system according to claim 1, wherein the adjustment processing is processing of making a decrease rate of a power conversion device with a high circuit temperature larger than a decrease rate of a power conversion device with a low circuit temperature when the power supplied to the battery is decreased.

4. The power generation system according to claim 1, wherein the adjustment processing is processing of making a decrease rate of a power conversion device with a high operation frequency larger than a decrease rate of a power conversion device with a low operation frequency when the power supplied to the battery is decreased.

5. The power generation system according to claim 1, wherein the adjustment processing is processing of performing power supply via the power conversion device with the small heat load and stopping power supply via the power conversion device with the large heat load when the power supplied to the battery is decreased.
